(19) United States
(12) Patent Application Publication
(10) Pub. No.: US 2026/0320469 A1
(43) Pub. Date: Oct. 15, 2026

(54) HYBRID DATA MIGRATION BETWEEN EXISTING SYSTEMS AND QUANTUM SYSTEMS

(71) Applicant: Bank of America Corporation, Charlotte, NC (US)

(72) Inventors: Vinayak Rao Patwari, Telangana (IN); Jhalak Khurana, Hisar (IN); Ambiga Nagapooshanam, Tamil Nadu (IN); Pravin Babu M, Tamil Nadu (IN); Aswinkumar Anbumani, Tamil Nadu (IN); Sandeep Kumar Chauhan, Hyderabad (IN); Deepthi Chintala, Hyderabad (IN)

(21) Appl. No.: 19/179,260

(22) Filed: Apr. 15, 2025

(51) Int. Cl. G06N 10/80; G06F 3/06

(52) U.S. Cl. CPC G06N 10/80; G06F 3/0619; G06F 3/0647

(57) ABSTRACT

A data migration method, a computing platform, and a non-transitory computer-readable medium for data migration are provided. The method, conducted by a first computing platform having one or more first processors, includes pre-processing data for a data migration, filtering, based on one or more rules, the pre-processed data, measuring, by using one or more quantum sensors, physical properties of the filtered data, annealing, based on the measured physical properties, the filtered data, and transferring, to a second computing platform, the annealed data via a quantum communication. The one or more rules may be configurable by an administrator or a high-level controller based on one or more goals set for the data migration. The first computing platform may be a traditional computing platform. The second computing platform may be a quantum computing platform.

### TECHNICAL FIELD

Generally, the present disclosure relates to a data migration method, a computing platform, and a system. More particularly, the present disclosure relates to data migration between computing systems.

### BACKGROUND

Data migration plays a crucial role in modern businesses and information technology (IT) operations that constantly face changing technological landscapes. By moving data from one system to another, an organization’s systems may be upgraded and modernized, data may be consolidated and optimized, and back-up systems and/or cloud infrastructures may be adopted and utilized. However, one of the biggest challenges for data migration is data compatibility between different types of systems, for example, between existing systems (e.g., traditional computing systems that operate on the principles of binary logic, such as 0 and 1) and future systems (e.g., quantum systems that operate on the principles of quantum mechanics, such as quantum bits (“qubits”)). The data compatibility can also cause significant data loss and/or data delay during a data transfer. As such, properly formatting and optimizing data for transferring between the existing systems and the quantum systems becomes a critical activity for the process of moving data between these two types of systems.

Examples described herein provide an existing system capable of transferring data to and receiving data from a quantum system, or vice versa, to make data migration between different types of systems possible.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

In some examples, the present disclosure may provide a method for migrating data. The method may include pre-processing data for a data migration, filtering, based on one or more rules, the pre-processed data, measuring, by using one or more quantum sensors, physical properties of the filtered data, annealing, based on the measured physical properties, the filtered data, and transferring, to a second computing platform, the annealed data via a quantum communication.

In some examples, the method may further include monitoring the data for potential issues for the data migration, and identifying the potential issues for the data migration.

In some examples, the method may further include identifying critical data for the data migration, and adding at least one of metadata and headers to the identified critical data.

In some examples, the method may further include serializing the data, and packaging the serialized data.

In some examples, the method may further include converting digital states of the data to quantum states of the data.

In some examples, the one or more rules may be configurable by an administrator or a high-level controller based on one or more goals set for the data migration.

In some examples, the method may further include optimizing the filtered data, and prioritizing the filtered data.

In some examples, the present disclosure may provide a computing platform. The computing platform may include at least one processor, a communication interface communicatively coupled to the at least one processor, and memory storing computer-readable instructions that, when executed by the at least one processor, cause the computing platform to execute methods described herein.

In some examples, the present disclosure may provide a non-transitory computer-readable medium, having computer-executable instructions stored thereon, the computer-executable instructions, when executed by one or more processors of a computing platform, cause the computing platform to facilitate executing methods described herein.

### BRIEF DESCRIPTION OF THE DRAWINGS

The present disclosure is illustrated by way of example and not limited in the accompanying figures in which like reference numerals indicate similar elements and in which:

FIG. 1 illustrates an example of an overview of data migration between an existing computing platform and a quantum computing platform according to some examples of the present disclosure;

FIG. 2 illustrates a schematic diagram of a data transfer from an existing computing platform to a quantum computing platform according to some examples of the present disclosure;

FIG. 3 illustrates a schematic diagram of another data transfer from an existing computing platform to a quantum computing platform according to some examples of the present disclosure;

FIG. 4 illustrates a schematic flowchart of a method for transferring data from an existing computing platform to a quantum computing platform according to some examples of the present disclosure;

FIG. 5 illustrates a schematic flowchart of a method for a quantum computing platform receiving data transferred from an existing computing platform according to some examples of the present disclosure;

FIG. 6 illustrates a schematic flowchart of another method for a quantum computing platform receiving data transferred from an existing computing platform according to some examples of the present disclosure;

FIG. 7 illustrates a schematic diagram of a data transfer from a quantum computing platform to an existing computing platform according to some examples of the present disclosure;

FIG. 8 illustrates a schematic flowchart of a method for transferring data from a quantum computing platform to an existing computing platform according to some examples of the present disclosure;

FIG. 9 illustrates a schematic flowchart of a method for an existing computing platform receiving data transferred from a quantum computing platform according to some examples of the present disclosure; and

FIG. 10 illustrates a schematic diagram of a computing platform for transferring data to and/or receiving data from another computing platform of a different type according to some examples of the present disclosure.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

The present disclosure provides a computing platform (e.g., an existing, traditional computing platform) that transfers data to and receives data from another computing platform of a different type (e.g., a quantum computing platform). One or more processors of the computing platform may be configured to pre-process data based on a project’s scope, goal, budget, timeline, and destination computing platform. The one or more processors may be configured to identify potential data migration issues and add corresponding metadata/headers to facilitate monitoring real-time data transfer between different types of computing platforms. The one or more processors may be configured to serialize (also known as package) the data, such as converting complex data structures into a format that can be stored, transmitted across a network, and/or passed between processes. The one or more processors may be configured to convert digital 0 and digital 1 of the traditional computing platform into qubits used for the quantum computing platform. The one or more processors may be configured to filter the data to be transferred based on rules defined by a high-level controller so that targeted data may be prepared further for a transfer and the remaining data may be filtered out. The further preparation of the targeted data may include measuring physical properties of the data at a quantum level and in quantum states by using a quantum sensor. The further preparation of the targeted data may also include optimizing and refining the data through an annealing process, and further, prioritizing one or more data sets for the data transfer. Accordingly, the one or more processors may be configured to transfer the data.

The one or more processors may also be configured to receive data transferred from a computing platform of a different type (e.g., a quantum computing platform). For example, the one or more processors may be configured to identify any missing data packages or delay in data transfer, and accordingly, to return to the quantum computing platform and request to regenerate the missing or delayed data, and/or may be configured to re-purpose the missing or delayed data. The one or more processors may be configured to extract results from the received data if it determines that no data loss or data delay occurs, and maintain the received data for the planned projects or future uses.

The present disclosure provides a computing platform (e.g., a quantum computing platform) that transfers data to and receives data from another computing platform of a different type (e.g., an existing, traditional computing platform). One or more processors of the computing platform may be configured to measure physical properties of quantum data by using a quantum sensor. The one or more processors may be configured to arrange or process qubits in a sequential manner through a process of serialization (also known as packaging) for the data transfer. The one or more processors may also be configured to identify critical data for the data transfer, and accordingly, package and encode the data. The one or more processors may further be configured to add metadata and/or headers to the identified critical data to monitor real-time data transfer for any potential data migration issues. The one or more processors may be configured to convert states of the quantum data to states of digital 0 and digital 1 that are used for the destination computing platform (e.g., an existing, traditional computing platform), and further, extract the digital states for further processing. The one or more processors may be configured to optimize and refine, and further, prioritize the converted data through an annealing process, for example, based on the data importance and/or data relevance. Accordingly, one or more data sets/batches may be prioritized for data transfer. The one or more processors may further be configured to verify and calibrate the prioritized data sets/batches, and start to transfer these prioritized data sets/batches with high accuracy.

The one or more processors may also be configured to receive data transferred from a computing platform of a different type (e.g., an existing, traditional computing platform). For example, the one or more processors may be configured to verify and validate the received data, and accordingly, determine whether there is any data loss or data delay during the data transfer. The one or more processors may be configured to return to the traditional computing platform and request to regenerate the missing data or delayed data, or may be configured to re-purpose the missing or delayed data, if there is any data loss or delay. The one or more processors may be configured to optimize the received data, and further, communicate with the traditional computing platform for integrating the quantum data received from the traditional computing platform if no data loss or data delay occurs. The one or more processors may be configured to analyze and maintain the quantum data for the planned projects or future uses.

The present disclosure provides methods for computing platforms of different types transferring data to and/or receiving data from another. The present disclosure provides a system that includes different types of computing platforms that migrate data between one and another.

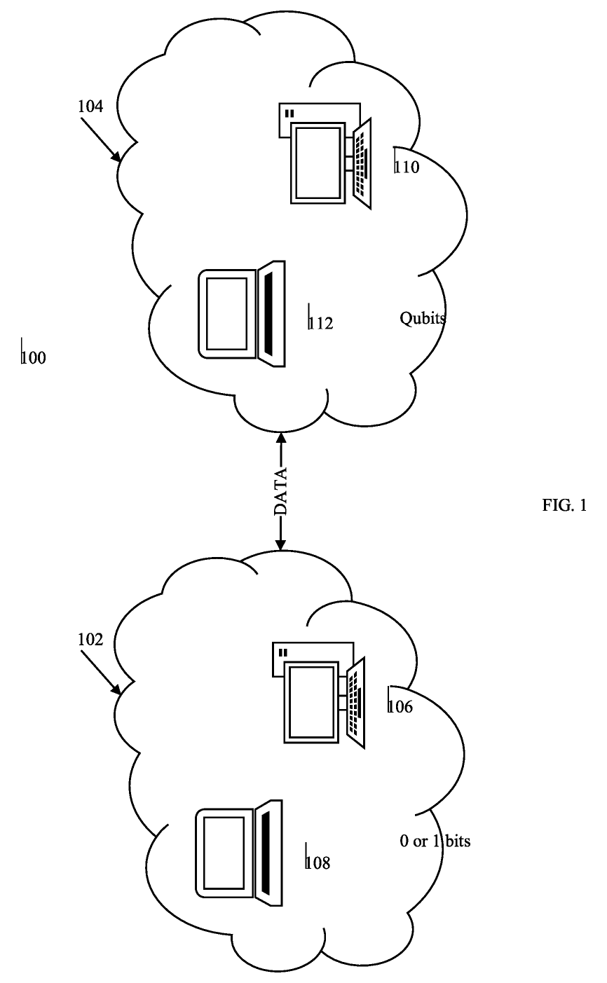

FIG. 1 illustrates an example of an overview of data migration between an existing computing platform (e.g., a traditional computing platform operating based on binary logic) and a quantum computing platform according to some examples of the present disclosure.

A system 100 may include one or more computing platforms of different types, among which data may be migrated. Each computing platform of the system 100 may include one or more computing devices of a same type. For example, the computing platform 102 may be an existing, traditional computing platform operating on binary logic that includes a computing device 106, such as a desktop, and a computing device 108, such as a laptop. The computing devices 106 and 108 may operate on the principles of binary logic, where data and instructions are represented using two distinct states, 0 and 1. The computing platform 102 may also include any other computing devices that operate on the digital states. The computing platform 104 may be a quantum computing platform that includes a computing device 110, such as a desktop, and a computing device 112, such as a laptop. The computing devices 110 and 112 may exhibit behavior governed by the principles of quantum mechanics and using qubits. The computing platform 104 may also include any other computing devices that use qubits to store and process information.

As shown, data may be migrated between the computing platforms 102 and 104, for day-to-day operation of an organization in a modern business environment. For example, migrating data from the traditional computing platform 102 to the quantum computing platform 104 may enable the organization to take advantage of exponential computational power. Data migration often happens when an organization replaces its legacy systems with more innovative solutions, moves data to cloud platforms, merges or consolidates data from multiple systems, builds up back-up systems, and/or standardizes data according to regulatory rules and requirements.

Examples of the present disclosure provide methods, computing platforms, and systems for migrating data of different types. For example, the data may be processed before being transferred by the computing platform 102 to the computing platform 104, or vice versa. The data may also be processed after being received by the computing platform 102 from the computing platform 104, or vice versa. As such, different types of data of different types of computing platforms may be migrated with minimal data loss and/or data delay.

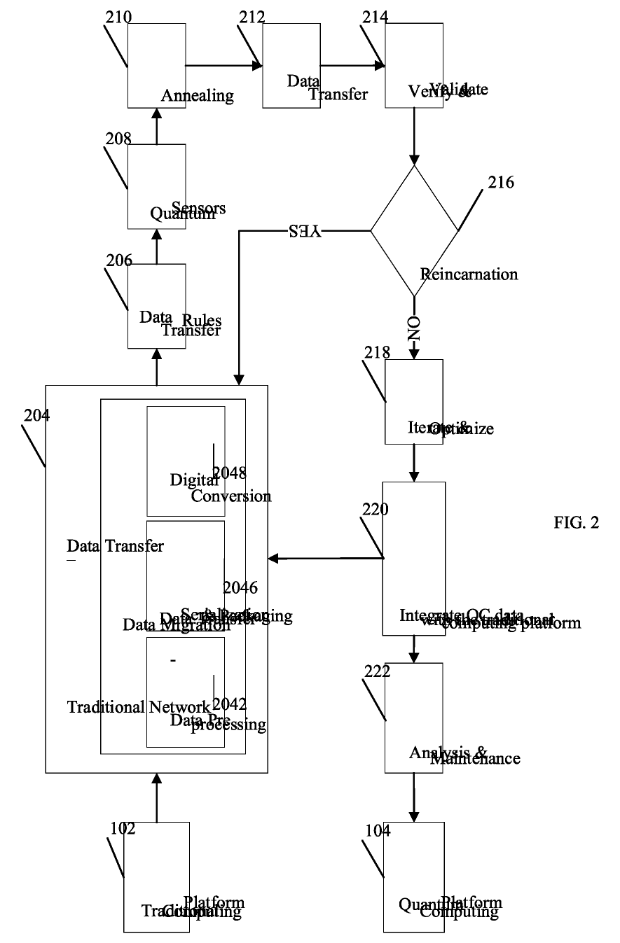

FIG. 2 illustrates a schematic diagram of a data transfer from an existing computing platform (e.g., a traditional computing platform operating based on binary logic) to a quantum computing platform according to some examples of the present disclosure.

An existing computing platform 102, for example, an existing, traditional computing platform 102, may start a data transfer by processing the data within a traditional network 204 for preparing a data migration to a quantum computing platform 104, for example, a quantum computing platform 104. Within the traditional network 204, the traditional computing platform 102 may pre-process the data at 2042, which may include identifying critical data so that the traditional computing platform 102 may monitor such data during the data transfer, and also, identifying any possible monitoring issues during the data transfer. The traditional computing platform 102 may add metadata and/or headers to the identified critical data and/or identified monitoring issues. The data pre-processing 2042 may also involve the traditional computing platform 102 reading the data and identifying any gaps among the data that may affect the data transfer and/or any use by the quantum computing platform 104 after the transfer.

Further, the traditional computing platform 102 may serialize and package the data at 2046, which may include converting complex data structures, such as objects, arrays, or nested structures, into a linear format, such as a sequence of bytes or a string. The traditional computing platform 102 may package the serialized data for the transfer. Another process of the data within the traditional network 204 may include digital conversion at 2048, which may involve the traditional computing platform 102 converting states of the data in 0 and 1 into quantum states of the data in qubits.

The data may be filtered based on one or more data transfer rules at 206, which are generally a filtering mechanism that is configurable by an administrator or a high-level controller. For example, the traditional computing platform 102 may filter the data based on use cases of the data for the quantum computing platform 104. Taking a banking institution as an example, in order to facilitate business through online banking, data related to customers’ personal information and patterns of online banking may be kept, and the remaining data may be filtered out. As such, the to-be-transferred data may be more specialized for the purpose of the data migration, and accordingly, the efficiency of the data migration may be enhanced.

The traditional computing platform 102 may feed the data to one or more quantum sensors at 208, which may measure physical properties of the data. As such, the traditional computing platform 102 may map the data into physical properties, and accordingly, represent the data encoded in digital bits (e.g., 0 and 1) as qubits, which can exist in superpositions of 0 and 1 within the quantum computing platform 104. The traditional computing platform 102 may further input the data into an annealing process 210, which may optimize and refine, and further, prioritize the data or prioritize one or more data sets/batches out of the data for data transfer. For example, the traditional computing platform 102 may prioritize the data or data sets through the annealing process 210 if some data or some data sets/batches need to be processed first by the quantum computing platform 104 due to their importance for a project or due to some urgent situations of the project. Accordingly, the traditional computing platform 102 may start to transfer the data at 212 to the quantum computing platform 104, for example, via a quantum communication.

The quantum computing platform 104 may verify and validate the data at 214 to see whether any data packages are missing or any data packages are delayed during the data transfer at 212 after it receives the data via a quantum communication. The quantum computing platform 104 may re-purpose the data, for example, by extracting additional value from the data and applying it to a different context and/or analysis than originally intended, to make sure the missing data or delayed data may not affect the use of the transferred data if missing data or delayed data is identified. The quantum computing platform 104 may also determine whether the data needs to be brought back at reincarnation 216 if it identifies missing data or delayed data, for example, if two sets of data packages are incomplete. Accordingly, the quantum computing platform 104 may feedback the information of missing or delayed data to the traditional computing platform 102, for example, to the data pre-processing at 2042, and request to resend the data at reincarnation 216. The quantum computing platform 104 may keep feedbacking the information and requesting the traditional computing platform 102 to resend the data that is missing or delayed until it determines that the data is complete.

The quantum computing platform 104 may determine to proceed with further steps for data migration at reincarnation 216 if no missing data or no delayed data is identified. For example, the quantum computing platform 104 may iterate and optimize the data at 218, which may involve systematically accessing and processing each element in the data one at a time in order to optimize the data. The quantum computing platform 104 may further communicate with the traditional computing platform 102 for integrating the data into its platform. The quantum computing platform 104 may then analyze and maintain the data at 222 for the use of the project or any future uses. As such, computational power of the quantum computing platform 104 may be utilized for processing the data to execute the project that is planned.

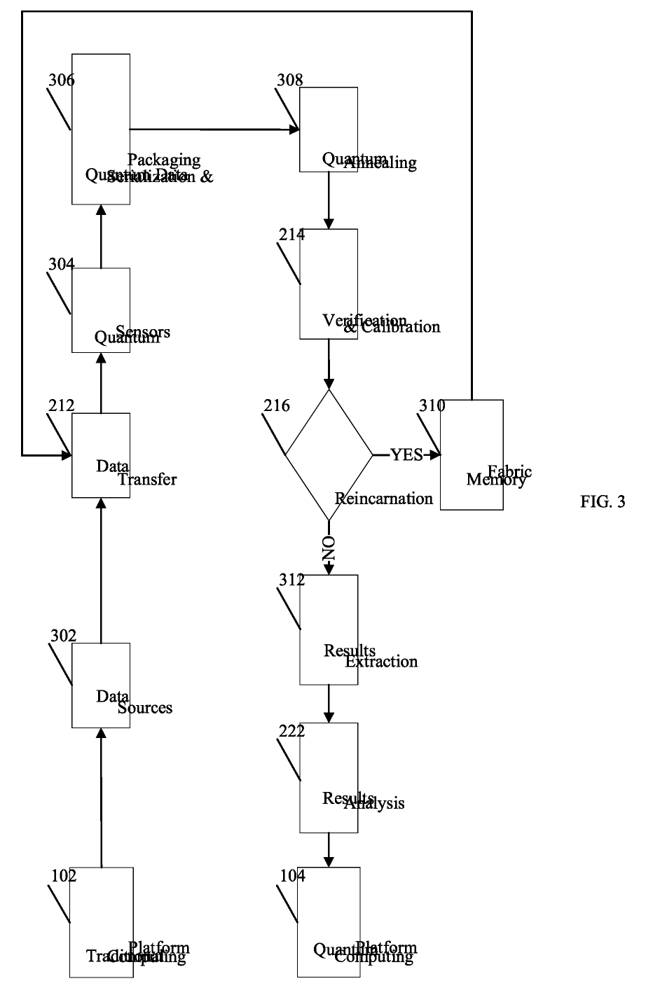

FIG. 3 illustrates a schematic diagram of another data transfer from an existing computing platform (e.g., a traditional computing platform operating based on binary logic) to a quantum computing platform according to some examples of the present disclosure.

The traditional computing platform 102 may process the data to be transferred at its data sources 302, which may include the processes of 204, 206, 208, and 210, and further, transfer the processed data (i.e., the quantum data) at 212, as described with reference to FIG. 2. The quantum computing platform 104 may receive the quantum data and process the quantum data for the migration. For example, the quantum computing platform 104 may measure physical properties of the quantum data by using one or more quantum sensors at 304, serialize and package the quantum data at 306, and optimize and refine, and further prioritize one or more data packages or data sets out of the quantum data through a quantum annealing process at 308. The quantum computing platform 104 may also verify and/or validate the quantum data at 214 so as to determine whether the data reincarnation 216 is necessary, as described with reference to FIG. 2.

The quantum computing platform 104 may reach out to a memory fabric 310 to check whether the missing data or delayed data is available at the memory fabric 310, for example, as a result of past data migrations, if it identifies any missing data or delayed data at 214. The quantum computing platform 104 may fetch the data straightaway and proceed with further processes if the missing data or delayed data is available at the memory fabric 310. The quantum computing platform 104 may return to the traditional computing platform 102 and request to re-transfer the data through the data transfer 212 if the missing data or delayed data is not available at the memory fabric 310. The memory fabric 310 may include memory, and/or other devices for storing information, data, instructions etc. The memory fabric 310 may be embedded in the quantum computing platform 104, installed in the system 100 of FIG. 1, and/or located remotely on a cloud platform or a remote server.

The quantum computing platform 104 may determine no reincarnation at 216 is necessary and proceed to extract results from the quantum data at 312 if no missing data or delayed data is identified at 214. The quantum computing platform 104 may analyze the extracted results at 222, as described with reference to FIG. 2. The feedback loop from the quantum computing platform 104 (the memory 310) to the traditional computing platform 102 (the data transfer 212) while the traditional computing platform 102 transfers the data to the quantum computing platform 104 may be in real-time, which could help improve the efficiency and speed of the data transfer and/or data migration.

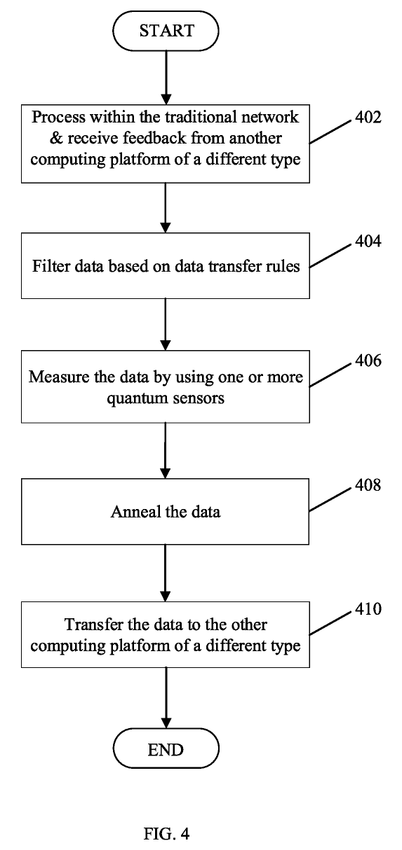

FIG. 4 illustrates a schematic flowchart of a method for transferring data from an existing computing platform (e.g., a traditional computing platform operating based on binary logic) to a quantum computing platform according to some examples of the present disclosure. One or more processors of a traditional computing platform, for example, a traditional computing platform 102 as shown in FIG. 1, may be configured to facilitate the following steps to transfer data to a quantum computing platform 104 as shown in FIG. 1.

At step 402, the one or more processors of the traditional computing platform 102 may be configured to process the data to be transferred within a traditional network. For example, the one or more processors may be configured to pre-process the data, serialize and package the data, and convert the data states to quantum states, as shown at 2042, 2046, and 2048 of FIG. 2, so to prepare the data for a data transfer.

At step 402, the one or more processors may be configured to receive feedback from the quantum computing platform 104 in the real-time of the data transfer through the steps 402, 404, 406, 408, and 410 (as will be detailed below). The feedback may include a request to re-transfer the data due to data loss or data delay. The feedback may include a request for information and/or support in order for the quantum computing platform 104 to integrate the data into its system. The feedback may include other types of information or requests.

At step 404, the one or more processors may be configured to filter the data based on one or more data transfer rules that are configured based on planned purposes of the data transfer, as shown at 206 of FIG. 2. For example, a planned purpose of a data transfer may be to enable business through online banking of a financial institute by using computational power offered by the quantum computing platform, such as the quantum computing platform 104 as shown in FIG. 1.

At step 406, the one or more processors may be configured to measure physical properties of the data by using one or more quantum sensors, as shown at 208 of FIG. 2.

At step 408, the one or more processors may be configured to anneal the data, i.e., to optimize and refine, and further, to prioritize one or more data packages or one or more data sets/batches out of the to-be-transferred data, as shown at 210 of FIG. 2.

At step 410, the one or more processors may be configured to transfer the processed data to the quantum computing platform 104, as shown at 210 of FIG. 2, via a quantum communication. As such, the data may be migrated from the traditional computing platform 102 to the quantum computing platform 104, and further, be processed by the quantum computing platform 104 to achieve the data transfer goal.

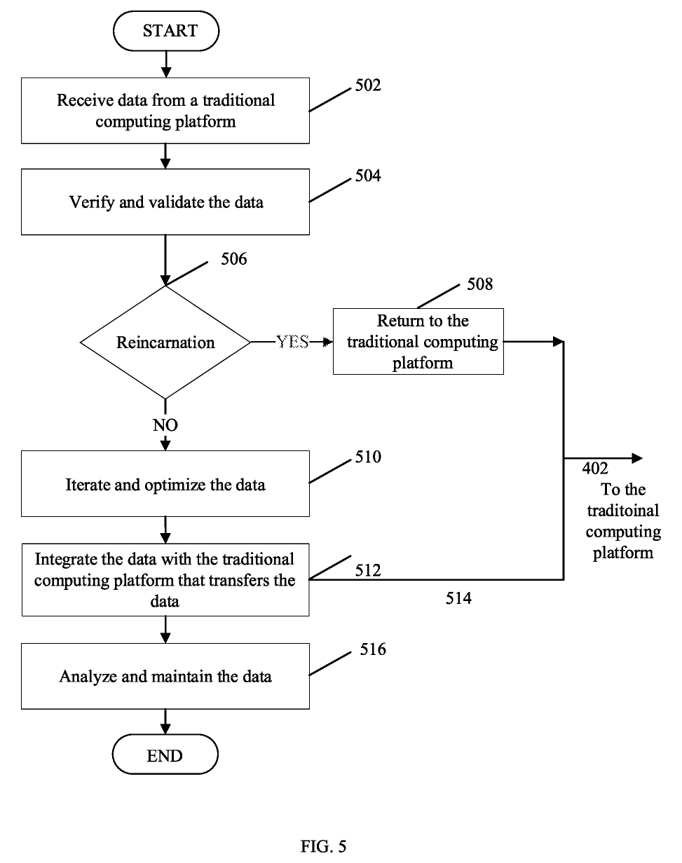

FIG. 5 illustrates a schematic flowchart of a method for a quantum computing platform receiving data transferred from an existing computing platform (e.g., a traditional computing platform operating based on binary logic) according to some examples of the present disclosure. One or more processors of a quantum computing platform, for example, a quantum computing platform 104 as shown in FIG. 1, may be configured to facilitate the following steps to receive data transferred by a traditional computing platform 102 as shown in FIG. 1.

At step 502, the one or more processors of the quantum computing platform 104 may be configured to receive the data transferred by the traditional computing platform 102 via a quantum communication. The data may also be transferred by another traditional computing platform of the system 100 as shown in FIG. 1.

At step 504, the one or more processors may be configured to verify and validate the received data to determine whether there is any data loss or data delay. The one or more processors may also be configured to take the received data intended for one use case and apply it to a new or distinct problem or analysis if there is any data loss or data delay.

At step 506, the one or more processors may be configured to determine whether any data reincarnation is necessary, for example, if it determines that data is lost or delayed. The one or more processors may be configured to proceed with step 508 if it determines data reincarnation is necessary.

At step 508, the one or more processors may be configured to return to the traditional computing platform 102 and request to re-transfer the data, which is the feedback received by the traditional computing platform 102 at step 402 as shown in FIG. 4.

At step 510, the one or more processors may be configured to iterate and optimize the data, as shown at 218 of FIG. 2, if it determines no data loss or data delay occurs during the data transfer or no data reincarnation is necessary. Accordingly, the one or more processors may be configured to further process the data for migrating the data.

At step 512, the one or more processors may be configured to integrate the data to the quantum computing platform 104.

At step 514, during the integrating process conducted at step 512, the one or more processors may be configured to communicate and work with the traditional computing platform 102 for integrating the data, which is the feedback received by the traditional computing platform 102 at step 402 as shown in FIG. 4.

At step 516, the one or more processors may be configured to analyze, and further, to maintain the data for the planned use of the data migration. Additionally and/or alternatively, the one or more processors may analyze and maintain the data for other types of future uses.

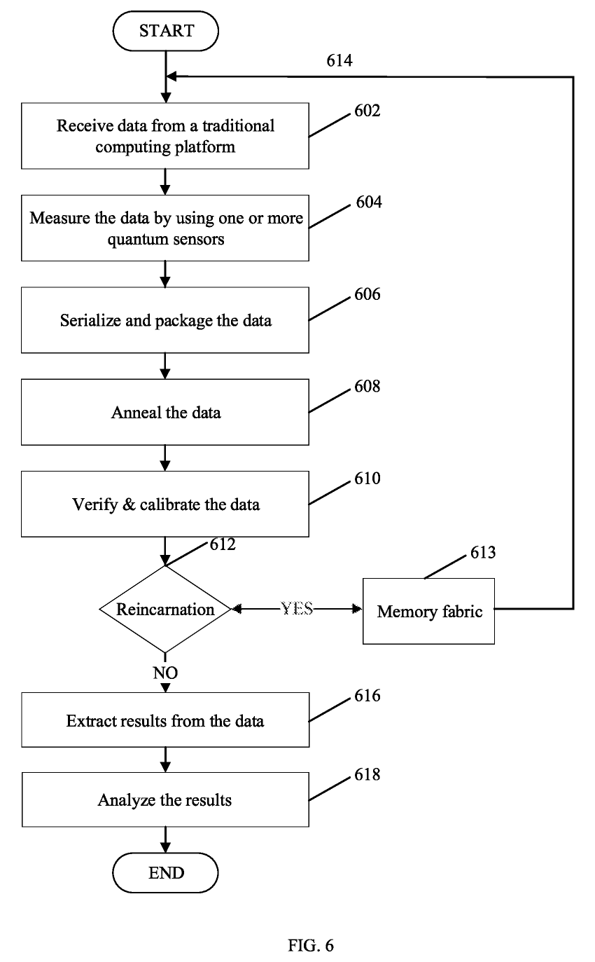

FIG. 6 illustrates a schematic flowchart of another method for a quantum computing platform receiving data transferred from an existing computing platform (e.g., a traditional computing platform operating based on binary logic) according to some examples of the present disclosure. One or more processors of a quantum computing platform, for example, a quantum computing platform 104 as shown in FIG. 1, may be configured to facilitate the following steps to receive data transferred by a traditional computing platform 102 as shown in FIG. 1.

At step 602, the one or more processors of the quantum computing platform 104 may be configured to received data (e.g., quantum data) from the traditional computing platform 102 via a quantum communication. For example, the data may be transferred by the traditional computing platform 102 at step 410 as shown in FIG. 4. The data may be transferred by another traditional computing platform of the system 100 as shown in FIG. 1.

At step 604, the one or more processors may be configured to measure physical properties of the data by using one or more quantum sensors so to obtain the physical properties carried by the data.

At step 606, the one or more processors may be configured to serialize the data and package the data so that the data can be more easily stored in a network and/or transmitted over a network.

At step 608, the one or more processors may be configured to anneal the data, for example, to optimize and refine, and further, to prioritize the data for further processing.

At step 610, the one or more processors may be configured to verify and/or calibrate the data so to determine whether any data is missing or delayed. The one or more processors may also be configured to determine whether to re-purpose the data, for example, if data is missing or delayed.

At step 612, the one or more processors may be configured to determine whether to reincarnate the data, if, for example, there is any data loss or data delay.

At step 613, the one or more processors may be configured to search in memory fabric (e.g., the memory fabric 310 as shown in FIG. 3) coupled to the quantum computing platform 104, for example, one or more storage devices, to determine whether the data that is lost or delayed may be available in the memory fabric 310.

At step 614, the one or more processors may be configured to return to the traditional computing platform 102 that transfers the data and request to re-transfer the missing or delayed data if such data is not available in the memory fabric.

At step 616, the one or more processors may be configured to extract the results from the data if it determines that there is no data loss or data delay.

At step 618, the one or more processors may be configured to analyze the results based on the purpose of the data migration. The one or more processors may also be configured to analyze the results for other types of uses of the data.

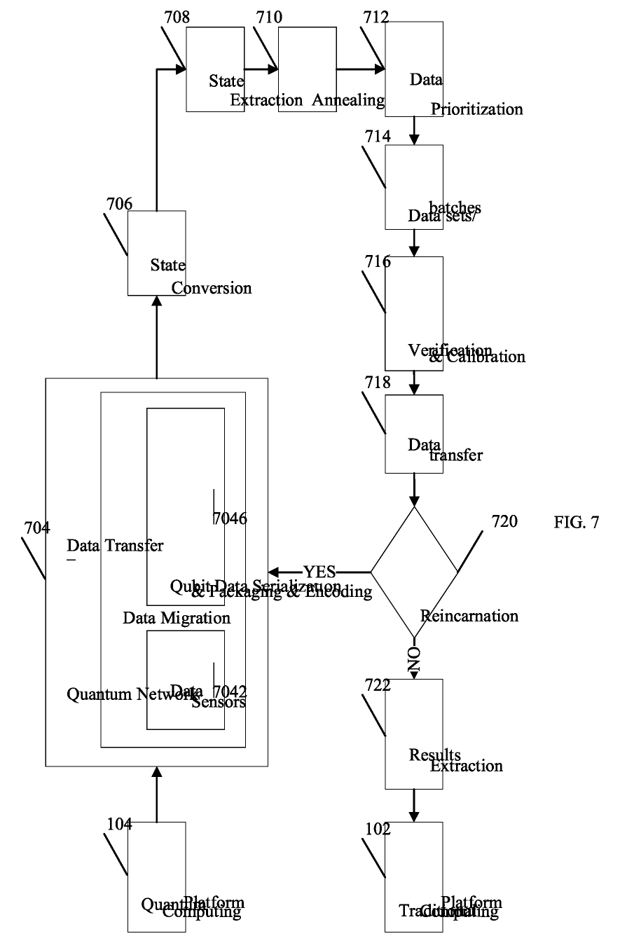

FIG. 7 illustrates a schematic diagram of a data transfer from a quantum computing platform to an existing computing platform (e.g., a traditional computing platform operating based on binary logic) according to some examples of the present disclosure.

A quantum computing platform 104, for example, a quantum computing platform 104, may start a data transfer by processing the data within a quantum network 704 for preparing a data migration to a traditional computing platform 102, for example, a traditional computing platform 102. Within a traditional network 704, the quantum computing platform 104 may pre-process the data to be transferred. For example, the quantum computing platform 104 may use one or more quantum sensors to measure physical properties of the quantum data at 7042. As such, the quantum computing platform 104 may be able to further represent these physical properties (e.g., in qubits) as abstract digital bits (e.g., 0 and 1) for the data transfer to the traditional computing platform 102 that operates on these abstract digital bits. The quantum computing platform 104 may serialize qubits of the quantum data, package the quantum data, and/or encode the quantum data at 7046 for transferring the data to the traditional computing platform 102. The quantum computing platform 104 may identify critical data and add metadata and/or headers to the identified critical data.

The quantum computing platform 104 may covert the data states in qubits at 706, which is used by the quantum computing platform 104, to the data states in digital, which is used by the traditional computing platform 102, for the data transfer. The quantum computing platform 104 may extract the converted states at 708 and anneal the data at 710. For example, the annealing process of the data at 710 may include the quantum computing platform 104 using an algorithm to optimize and refine the data, and/or to find patterns in the data for cost, performance, or other function considerations. As such, the data, especially large-scale or complex data, can be processed faster, more accurately, and more efficiently.

The quantum computing platform 104 may prioritize the data at 712 for various considerations. For example, the quantum computing platform 104 may consider whether some of the data is relatively more important, whether some of the data is necessary for relatively more urgent issues. The quantum computing platform 104 may be able to extract one or more data sets or data batches out of the entire data at 714 and prioritize the data sets/batches for the data transfer.

The quantum computing platform 104 may verify and calibrate the data at 716 before it starts the data transfer at 718. As such, the quantum computing platform 104 may be able to make sure the accuracy and correctness of the data to be transferred to the traditional computing platform 102 upfront. The quantum computing platform 104 may then start transferring the data at 718, for example, via a digital communication.

The traditional computing platform 102 may determine whether to reincarnate the data at 720 after it receives the data via a digital communication. For example, the traditional computing platform 102 may return to the quantum computing platform 104 if it determines that data is lost and/or data is delayed during the data transfer. The traditional computing platform 102 may also re-purpose the data for different uses than originally planned for the data transfer if it determines that data is lost and/or delayed.

The traditional computing platform 102 may extract results from the received data at 722 if it determines there is no data loss or data delay. The traditional computing platform 102 may process the received data based on planned use of the data migration. For example, the traditional computing platform 102 may be supported by a mature ecosystem of operating systems, including programming language, development tools, and framework. Accordingly, the traditional computing platform 102 may provide stable performance and handle a vast of tasks and everyday problems or applications with low cost and energy consumption.

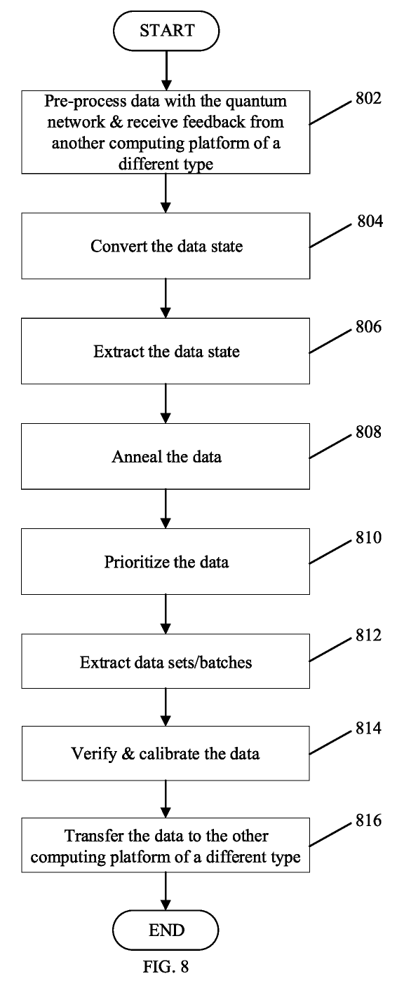

FIG. 8 illustrates a schematic flowchart of a method for transferring data from a quantum computing platform to an existing computing platform (e.g., a traditional computing platform operating based on binary logic) according to some examples of the present disclosure. One or more processors of a quantum computing platform, for example, a quantum computing platform 104 as shown in FIG. 1, may be configured to facilitate the following steps to transfer data to a traditional computing platform 102 as shown in FIG. 1.

At step 802, the one or more processors of the quantum computing platform 104 may be configured to pre-process the data to be transferred to the traditional computing platform 102. For example, the one or more processors may be configured to measure physical properties of the data by using one or more quantum sensors. The one or more processors may be configured to serialize, package, and encode the data based on the physical properties of the data so that the data may be further represented as abstract digital bits (e.g., 0 and 1), and arranged in an order of bits. The one or more processors may also be configured to identify critical data and add metadata and/or headers to the identified critical data.

At step 802, the one or more processors may be configured to receive feedback from the traditional computing platform 102 in the real-time of the data transfer through the steps 802, 804, 806, 808, 810, 812, 814, and 816 (as will be detailed below). The feedback may include a request to re-transfer the data due to data loss or data delay. The feedback may include a request for information in order for the traditional computing platform 102 to re-purpose the data due to the data loss or data delay. The feedback may include other types of information or requests.

At step 804, the one or more processors may be configured to convert the data states (e.g., qubits) to data states (e.g., digitals) so the digital data states may be used by the traditional computing platform 102.

At step 806, the one or more processors may be configured to extract the converted data states so these converted data states can be further processed.

At step 808, the one or more processors may be configured to anneal the data, for example, to optimize and refine the data to make it more suitable for the planned use of the data migration between two different types of the computing platforms.

At step 810, the one or more processors may be configured to prioritize the data so to transfer the data of importance or the data of urgency with priority.

At step 812, the one or more processors may be configured to extract data sets or data batches based on the data priority determined at step 810. The one or more processors may be configured to bundle the prioritized data into one or more data sets or into one or more data batches for the data transfer.

At step 814, the one or more processors may be configured to verify and calibrate the data so that the data to be transferred to the traditional computing platform 102 may be of greater accuracy and correctness. This would also enhance the efficiency of the data processing by the traditional computing platform 102 after it receives the data.

At step 816, the one or more processors may be configured to transfer the data to the traditional computing platform 102 via a digital communication.

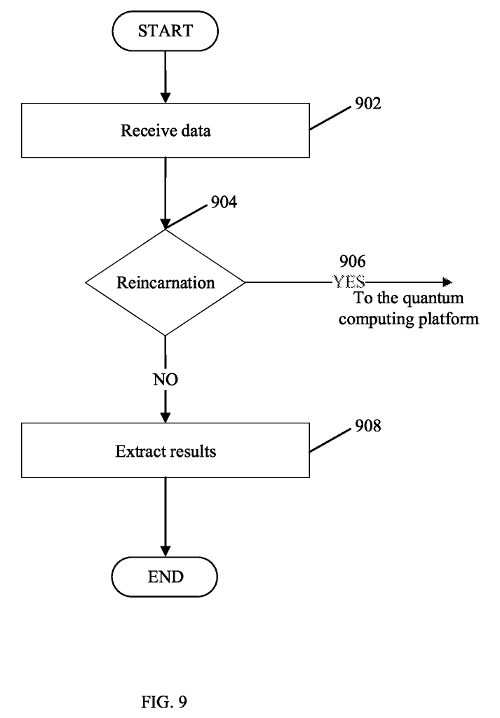

FIG. 9 illustrates a schematic flowchart of a method for an existing computing platform (e.g., a traditional computing platform operating based on binary logic) receiving data transferred from a quantum computing platform according to some examples of the present disclosure. One or more processors of a traditional computing platform, for example, a traditional computing platform 102 as shown in FIG. 1, may be configured to facilitate the following steps to receive data transferred by a quantum computing platform 104 as shown in FIG. 1.

At step 902, the one or more processors of the traditional computing platform 102 may be configured to receive the data transferred by the quantum computing platform 104 via a digital communication.

At step 904, the one or more processors may be configured to determine whether to reincarnate the received data due to data loss or data delay during the data transfer.

At step 906, the one or more processors may be configured to return to the quantum computing platform 104, which is the feedback received by the quantum computing platform 104 at step 802 as shown in FIG. 8, and request to re-transfer the data if data is lost or delayed during the data transfer. The one or more processors may also be configured to re-purpose the data if they determine that there is data loss or data delay.

At stop 908, the one or more processors may be configured to extract the results of the data received from the quantum computing platform 104 if no data loss or data delay occurs during the data transfer.

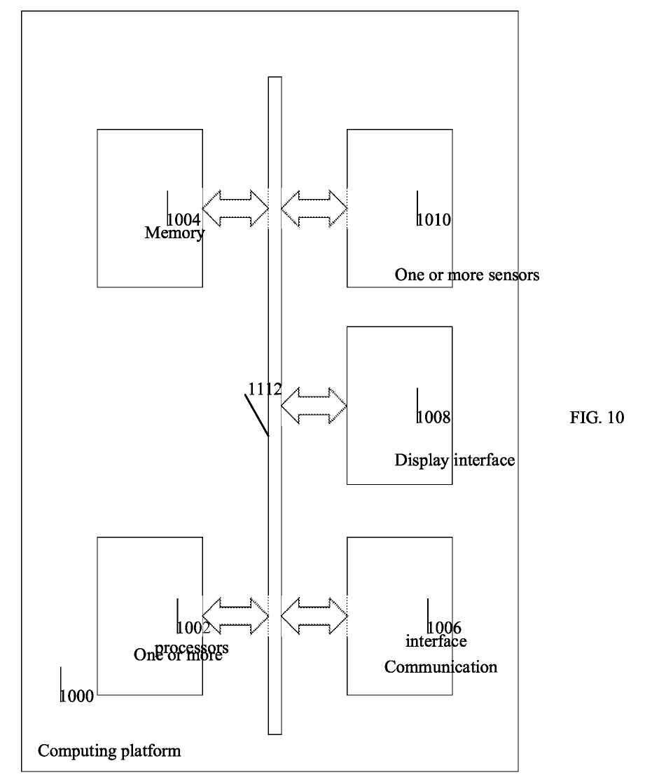

FIG. 10 illustrates a schematic diagram of a computing platform for transferring data to and/or receiving data from another computing platform of a different type according to some examples of the present disclosure.

The computing platform 1000 may include one or more processors 1002, memory 1004, and a communication interface 1006. The computing platform 1000 may include a bus 1112, through which the one or more processors 1002, the memory 1004, the communication interface 1006, and other components of the computing platform 1000 may exchange information with each other.

The computing platform 1000 may include a display interface 1008. For example, the display interface 1008 may or the one or more processors 1002 may trigger the display interface 1008 to display data processing status at the computing platform 1000, as shown in FIGS. 4, 5, 6, 8, and 9. For example, the display interface 1008 may display progress of receiving data (from another computing platform) and transferring data (to another computing platform), as shown in FIGS. 4, 5, 6, 8, and 9. Additionally and/or alternatively, the display interface 1008 may display other types of information. Additionally and/or alternatively, the display interface 1008 may be independent from the computing platform 1000 (e.g., part of a user inputting device).

The computing platform 1000 may include one or more sensors 1010, for example, one or more quantum sensors 1010. The one or more processors 1002 may take advantage of the exceptional precision and sensitivity provided by the one or more quantum sensors 1010 to measure physical properties of data, such as minute change in energy, time, magnetic fields, gravity. Additionally and/or alternatively, the one or more processors 1002 may use the one or more quantum sensors 1010 to measure other types of physical properties. Additionally and/or alternatively, the one or more quantum sensors 1010 may be independent from the computing platform 1000.

The one or more processors 1002 may include one or more general-purpose processors, such as a central processing unit (CPU), or a combination of a CPU and a hardware chip. The hardware chip may be an application-specific integrated circuit (ASIC), a programmable logic device (PLD), or a combination thereof. The PLD may be a complex programmable logic device (CPLD), a field-programmable gate array (FPGA), generic array logic (GAL), or any combination thereof. The one or more processors 1002 may also include processors that operate on quantum principles, such as qubits.

The memory 1004 may include volatile memory, for example, random-access memory (RAM). The memory 1004 may further include non-volatile memory (NVM), for example, read-only memory (ROM), flash memory, hard disk drive (HDD), or solid-state drive (SSD). The memory 1004 may further include a combination of the foregoing types. The memory 1004 may also include one or more storage devices or storage drives that are configured to store quantum data.

The memory 1004 may have computer-readable program codes stored thereon. The one or more processors 1002 may read the computer-readable program codes stored on the memory 1004 to perform the method described according to FIGS. 4, 5, 6, 8, and 9 data migration between two different types of computing platforms. Additionally and/or alternatively, the one or more processors 1002 may read the computer-readable program codes stored on the memory 1004 to perform one or more other functions, or a combination of these functions.

The one or more processors 1002 may further communicate with another computing device through the communication interface 1006. For example, the one or more processors 1002 may further communicate with external physical memory or external memory on a cloud platform or a cloud infrastructure to obtain data that are transferred and stored for previous projects, as shown in FIG. 6, to enhance the efficiency of the data migration.

A person of ordinary skill in the art will appreciate that the computing platform 1000 as shown in FIG. 10 may communicate with one or more further computing devices through the communication interface 1006 or wireless connections for further functions, or a combination of functions. Further, the computing platform 1000 as shown in FIG. 10 may also include one or more further functional components to perform and/or trigger further functions, or a combination of functions.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method for migrating data, comprising:
pre-processing, by a first computing platform having one or more first processors, data for a data migration;
filtering, by the one or more first processors and based on one or more rules, the pre-processed data;
measuring, by the one or more first processors and by using one or more quantum sensors, physical properties of the filtered data;
annealing, by the one or more first processors and based on the measured physical properties, the filtered data; and
transferring, by the one or more first processors and to a second computing platform, the annealed data via a quantum communication.

2. The method of claim 1, wherein the pre-processing comprises:
monitoring, by the one or more first processors, the data for potential issues for the data migration; and
identifying, by the one or more first processors, the potential issues for the data migration.

3. The method of claim 1, wherein the pre-processing comprises:
identifying, by the one or more first processors, critical data for the data migration; and
adding, by the one or more first processors, at least one of metadata and headers to the identified critical data.

4. The method of claim 1, wherein the pre-processing comprises:
serializing, by the one or more first processors, the data; and
packaging, by the one or more first processors, the serialized data.

5. The method of claim 1, wherein the pre-processing comprises:
converting, by the one or more first processors, digital states of the data to quantum states of the data.

6. The method of claim 1, wherein the one or more rules are configurable by an administrator or a high-level controller based on one or more goals set for the data migration.

7. The method of claim 1, wherein the annealing comprises:
optimizing, by the one or more first processors, the filtered data; and
prioritizing, by the one or more first processors, the filtered data.

8. A computing platform, comprising:
at least one processor;
a communication interface communicatively coupled to the at least one processor; and
memory storing computer-readable instructions that, when executed by the at least one processor, cause the computing platform to:
pre-process data for a data migration;
filter, based on one or more rules, the pre-processed data;
measure, by using one or more quantum sensors, physical properties of the filtered data;
anneal, based on the measured physical properties, the filtered data; and
transfer, to a second computing platform, the annealed data via a quantum communication.

9. The computing platform of claim 8, wherein the computer-readable instructions further cause the computing platform to:
monitor the data for potential issues for the data migration; and
identify the potential issues for the data migration.

10. The computing platform of claim 8, wherein the computer-readable instructions further cause the computing platform to:
identify critical data for the data migration; and
add at least one of metadata and headers to the identified critical data.

11. The computing platform of claim 8, wherein the computer-readable instructions further cause the computing platform to:
serialize the data; and
package the serialized data.

12. The computing platform of claim 8, wherein the computer-readable instructions further cause the computing platform to:
convert digital states of the data to quantum states of the data.

13. The computing platform of claim 8, wherein the one or more rules are configurable by an administrator or a high-level controller based on one or more goals set for the data migration.

14. The computing platform of claim 8, wherein the computer-readable instructions further cause the computing platform to:
optimize the filtered data; and
prioritize the filtered data.

15. A non-transitory computer-readable medium, having computer-executable instructions stored thereon, the computer-executable instructions, when executed by one or more processors of a computing platform, cause the computing platform to facilitate:
pre-processing data for a data migration;
filtering, based on one or more rules, the pre-processed data;
measuring, by using one or more quantum sensors, physical properties of the filtered data;
annealing, based on the measured physical properties, the filtered data; and
transferring, to a second computing platform, the annealed data via a quantum communication.

16. The non-transitory computer-readable medium of claim 15, wherein the computer-executable instructions further cause the computing platform to facilitate:
monitoring the data for potential issues for the data migration; and
identifying the potential issues for the data migration.

17. The non-transitory computer-readable medium of claim 15, wherein the computer-executable instructions further cause the computing platform to facilitate:
identifying critical data for the data migration; and
adding at least one of metadata and headers to the identified critical data.

18. The non-transitory computer-readable medium of claim 15, wherein the computer-executable instructions further cause the computing platform to facilitate:
serializing the data; and
packaging the serialized data.

19. The non-transitory computer-readable medium of claim 15, wherein the computer-executable instructions further cause the computing platform to facilitate:
converting digital states of the data to quantum states of the data.

20. The non-transitory computer-readable medium of claim 15, wherein the one or more rules are configurable by an administrator or a high-level controller based on one or more goals set for the data migration.
